(19) United States
(12) Patent Application Publication
(10) Pub. No.: US 2006/0059111 A1
(43) Pub. Date: Mar. 16, 2006

(54) Authentication method for securely disclosing confidential information over the internet

(76) Inventors: David Maxwell Tucker, Parkinson (AU); Brook Christopher Lewis, Carindale (AU); Jerome Witmann, Ejffel (FR); Matthew Thomas Keen, Chanhassen, MN (US); Craig Paul Lucas, Ashgrove (AU)

Correspondence Address: FENWICK & WEST LLP, SILICON VALLEY CENTER, 801 CALIFORNIA STREET, MOUNTAIN VIEW, CA, 94041, US

(21) Appl. No.: 10/937,893

(22) Filed: Sep. 10, 2004

(51) Int. Cl. G06F 17/60

(52) U.S. Cl. 705/75

(57) ABSTRACT

An authentication method for securely disclosing confidential information over the internet using a three way authentication between the user, the user's registered computer and the transacting entity, such as a bank or other financial institution. The authenticating method applies another layer of security to internet transactions and provides a solution against phishing scams.

### FIELD OF INVENTION

The present invention relates to authentication methods for use over the internet. The present invention has particular but not exclusive application for use with accessing a bank account using internet banking.

### BACKGROUND OF THE INVENTION

Internet use to access bank websites and perform transactions with one or more of a user's bank accounts is becoming increasingly popular because of its speed and convenience. However there has been an increase in spam email that fraudulently pose as representing a bank or financial institution to extract confidential and sensitive information from an unwary person. Persons sending these spam emails direct a user to a website that is a replica of an existing bank or financial institution website and invite the unwary user to enter important sensitive and or confidential information that will give these persons access to their bank accounts and allow them to steal money from their accounts. This type of scam has been termed “phishing” for internet spammers use email lures to fish for personal and sensitive information from the sea of internet users. Tracing and capturing proponents of this activity is neither easy nor highly successful.

Many of the solutions proposed to counter the problem have been reactive and have included introducing password authentication. Others such as Verisign, have developed systems employing authentication with the use of digital signatures. There does not appear to a satisfactory solution to the problem.

### OBJECT OF THE INVENTION

It is an object of the present invention to provide an authentication method for securely disclosing confidential information over the internet overcoming at least in part one or more of the above mentioned problems.

### SUMMARY OF THE INVENTION

In one aspect the present invention broadly resides in an authentication method for securely disclosing confidential information over the internet, including:

opening the bank sign-in URL using a customer's computer which has been registered and activated for use by the customer for internet banking;

receiving the bank identification tags in the sign-in web page on the customer's computer from a bank server;

sending the bank identification tags from the customer's computer to an authentication server for their validation as a trusted source;

validation of the bank identification tags by the authentication server and generation of an authentication code;

sending to and validating the authentication code on the customer's computer and generating a new request which includes the authentication code to the bank;

returning the sign-in web page from the bank with the authentication code embedded therein to the customer's computer;

entering sign-in information into the request and submitting the request to the bank, said submitted request also includes the authentication code;

validating the sign-in information against the computer's unique identifier recorded with registration and activation by the bank; wherein verification of the sign-in information and the computer's unique identifier confirms that the customer, customer's computer and the bank are trusted sources.

The requests and responses are preferably sent and received respectively via interface software to the bank. The interface software on the customer's computer is preferably compatible with the banks protocols and processing.

The bank identification tags preferably include the Bank Global Unique Identifier (BGUID), the Transaction ID (TID). The bank identification tags also preferably include a token TAG that is recognizable by the computer software.

Validation of the bank identification tags by the authentication server preferably occurs by checking a bank's BGUID and IP against a known list of bank servers.

The sign-in information preferably includes user identification (UID) and a password (PWD).

The computer's unique identifier is preferably a Machine Global Unique Identifier (MGUID). More preferably the computer's unique identifier includes a Machine Global Unique Identifier (MGUID) and a machine's Finger Print Identifier (FPID).

The method is preferably encoded in software programs readable by computer processors.

Reference in the specification to a bank or banking services includes reference to all financial institutions and their services and any other entity that requires the input of confidential or sensitive information from a user.

In another aspect the invention broadly resides in an authentication method for securely disclosing confidential information over the internet, including:

opening the secure site sign-in URL using a customer's computer which has been registered and activated for use by the customer with the secure site;

receiving the secure site identification tags in the sign-in web page on the customer's computer from a secure site server;

sending the secure site identification tags from the customer's computer to an authentication server for their validation as a trusted source;

validation of the secure site identification tags by the authentication server and generation of an authentication code;

sending to and validating the authentication code on the customer's computer and generating a new request which includes the authentication code to the secure site;

returning the sign-in web page from the secure site with the authentication code embedded therein to the customer's computer;

entering sign-in information into the request and submitting the request to the secure site, said submitted request also includes the authentication code;

validating the sign-in information against the computer's unique identifier recorded with registration and activation by the secure site; wherein verification of the sign-in information and the computer's unique identifier confirms that the customer, customer's computer and the secure site are trusted sources.

Preferably the method of the invention can be applied to any secured site of an entity where there is a desire or requirement to establish user trust.

The reference to bank includes any entity where confidential or sensitive information is transferred between the user and the entity and the features described with respect to internet banking also apply to the entity and its website.

### BRIEF DESCRIPTION OF THE DRAWINGS

In order that the present invention can be more readily understood and put into practical effect, reference will now be made to the accompanying drawings wherein:

FIG. 1 is a flow diagram of the process of installing and using the software coding for the authentication method of the preferred embodiment;

FIG. 2 is a diagrammatic view of the interaction of the different components of the authentication system of the preferred embodiment;

FIG. 3 is a flow diagram of the installing and registration process of the authentication method of the preferred embodiment;

FIG. 4 is a flow diagram of the activation process of the authentication method of the preferred embodiment; and

FIG. 5 is a flow diagram of the use of the authentication method of the preferred embodiment.

### DETAILED DESCRIPTION OF THE PREFERRED EMBODIMENT

The authentication method for securely disclosing confidential information over the internet was developed to complement current authentication processes by producing another layer of protection. The authentication method of the preferred embodiment is a different type of authentication to the current authentication processes of logging in and providing a password and relies on authenticating the bank or financial institution, the customer and the computer that the customer uses to perform their transactions. In this way, a three way trust relationship between the bank, the customer and the customer's computer is established and if authentication is not achieved by any one component, access is denied. In effect the authentication method of the preferred embodiment links a customer with a particular computer.

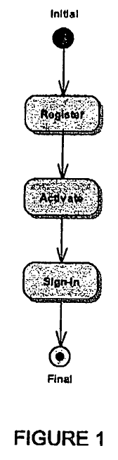

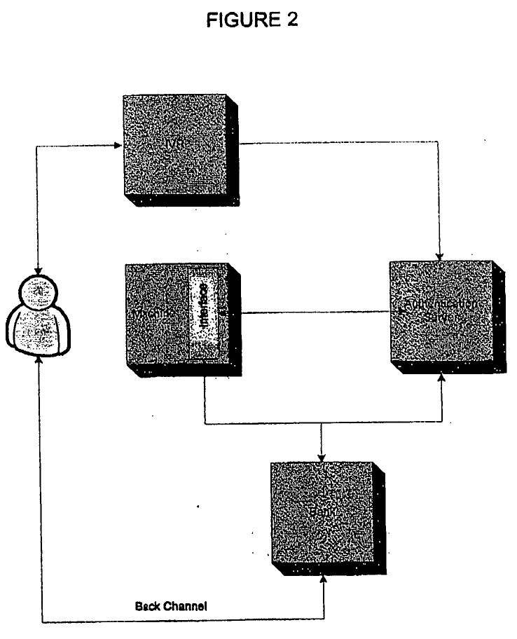

The authentication method of the preferred embodiment requires that the software coding for the method is registered and activated prior to use as shown in FIG. 1. The interaction of the various components is shown in FIG. 2.

### 1. Registration of the Software Coding for the Authentication Method

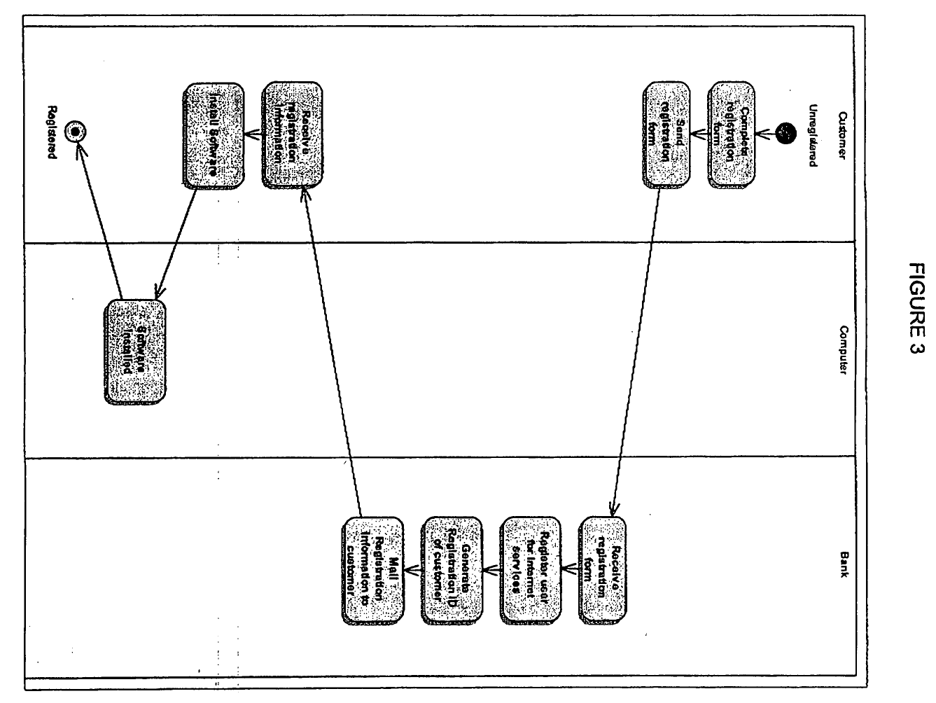

To access the internet banking services, the customer is required to register their computer that they intend to use for internet banking. The process for registration is shown in FIG. 3 and involves the following steps.

The customer completes a registration form for access to the internet banking services. The customer then sends the registration form to the bank customer service centre. The bank then receives the registration form and processes the form. The application and sending can be performed online, faxed, mailed or over the phone. The bank registers the customer for banking internet services and generates Sign-In credentials: User ID (UID) and Password (PWD). The credentials are stored on the bank servers. The bank also generates a Registration ID (REGID) and stores the REGID against the UID and PWD. As an alternate approach, the solution supports a request by the bank for the Authentication Server to generate of the Transaction ID and the return of the value, via secure channels, to the bank.

The bank mails the registration information to the customer. The customer receives the registration information and acquires the software. The customer then installs the software. The software installation process generates a Machine Unique Identifier (MGUID) and a Finger Print Identifier (FPID) as determined from the computer's hardware configuration. Both identifiers are secured in a local encrypted store. The customer has completed the registration process but must activate the software before accessing the banking internet services using the registered computer.

The registration process is repeated for each computer a customer wishes to use, but does not restrict multiple customers from using the same computer. To complete this process, the customer receives a software package, either stand-alone or integrated component of a commercial product, which is installed on the computer. The software package is termed the software interface within the specification. Upon installation, the software interface will generate a Machine Unique Identifier (MGUID) and construct a Finger Print Identifier (FPID) from an analysis of the hardware configuration. The FPID may not be unique for each computer. These values are secured in a local encrypted store.

### 2. Activating the Software Coding for the Authentication Method

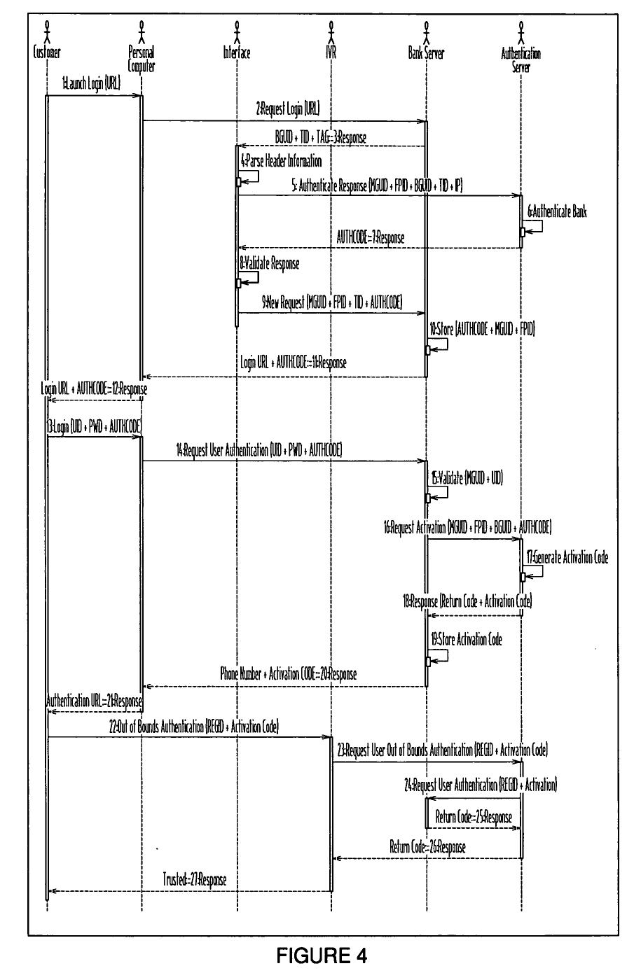

After the customer has registered for internet banking services and installed the software interface, the customer is required to activate the computer to use the internet banking services. This process is shown in FIG. 4. This process is triggered with the first attempt of using (or signing in) to the internet banking services from an inactivated computer.

The “Sign-in” process is achieved by the customer opening the authentic bank Sign-in URL in an internet browser and entering the valid credentials to access personal bank accounts. Upon this action, the activation process will detect an attempted access to the customer's personal bank accounts originating from a computer that is not trusted.

The customer launches the authentic Bank Sign-In URL in an internet browser on the computer. The interface software, installed as part of the registration process, passes the request through the computer's internet connection. The bank server receives the request and responds with the Sign-In web page. Header information contained in the web page includes the Bank Global Unique Identifier (BGUID), the Transaction ID (TID), and the token TAG as recognized by the software interface. As an alternate approach, the solution supports a request by the bank for the authentication server to generate of the Transaction ID and the return of the value, via secure channels, to the bank. The software interface parses the header information and acknowledges the inclusion of the token TAG. The software interface parses out the header fields of the response and requests that the Authentication server validate the BGUID as a trusted source. The request passes the BGUID, the TID and the IP of the bank server. This is performed via secure channels.

The authentication server validates the BGUID and IP against a known list of bank servers. The BGUID is trusted for the bank server IP and the authentication server generates an Authentication Code (AUTHCODE) which is stored against the BGUID, TID and IP. The AUTHCODE is returned in a formatted response to the software interface. This is performed via secure channels.

The software interface validates the response from the authentication server. The software interface generates a new request to the bank server to store the AUTHCODE against the Machine Global Unique Identifier (MGUID), TID and Finger Print Identifier (FPID). The request passes the AUTHCODE, MGUID, TID and FPID. The bank server stores the AUTHCODE against the MGUID, TID and the FPID. The bank server returns the Sign-In web page with the AUTHCODE embedded in the page. The software interface passes this response directly through to the internet browser as no token TAG is included in the header information.

The customer enters the Sign-In credentials, User ID (UID) and password (PWD), and submits the information to the bank server. The request passes the UID, PWD and the AUTHCODE. The software interface passes the Sign-In request through to the bank server. The bank server validates the UID and PWD as submitted by the customer. The customer's credentials are validated but the MGUID is not linked with the UID and thus is not a trusted source.

As the computer is not a trusted source the bank server retrieves the MGUID, TID, and FPID using the AUTHCODE passed in and requests the Authentication server generate an Activation Code for this MGUID. The authentication server validates the request and generates an Activation Code. The Activation Code is stored against the BGUID, MGUID, TID and FPID. The authentication server returns the Activation Code to the bank server. The bank server stores the Activation Code against the UID.

The bank server requests the customer activate the internet services for the computer. The bank server returns the Activation web page that contains the Activation Code, the phone number to dial to complete the activation, instructions to activate including references to the information received by the customer at the end of the registration process. The software interface passes this response directly through to the internet browser as no token TAG is included in the header information.

The customer proceeds with the out-of-band authentication by dialing the IVR (interactive voice response) number as displayed on the Activation web page. The IVR system requests the customer enter the Activation Code as displayed on the Activation web page and the Registration ID as displayed on the registration information received via mail.

The IVR system requests the validation of the activation. The IVR passes the Activation Code and the Registration ID to the Authentication server. The Authentication server validates the Activation Code as a previously generated code and requests the Bank server to validate the Activation Code and Registration ID against the MGUID and AUTHCODE. The Authentication server passes the Activation Code and the Registration ID to the Bank server. The bank server validates the Activation Code against the MGUID and the AUTHCODE. The bank server performs a customer credential check using the Registration ID and stored MGUID against the UID activating the computer for the customer. The bank server passes to the Authentication server that the computer is a trusted source. The authentication server passes this response to the IVR. The IVR informs the customer the activation process has been completed successfully.

### 3. Internet Banking Using the Software Coding for the Authentication Method

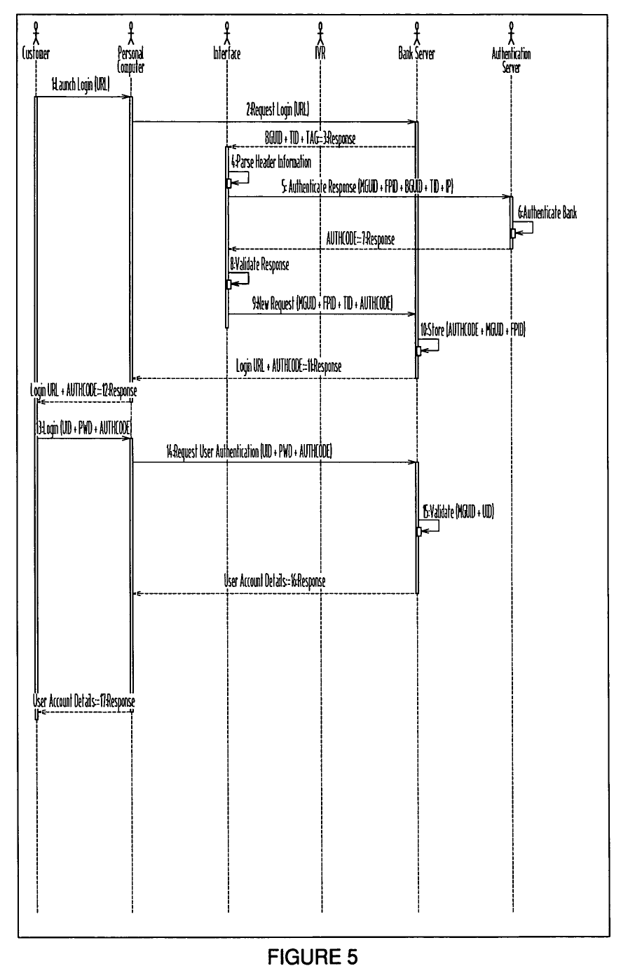

The customer having successfully activated the banking internet services can now use the internet banking services using the registered computer. This is shown in FIG. 5.

The customer launches the authentic bank Sign-In URL in an internet browser on the computer. The interface software, installed as part of the registration process, passes the request through the computer's internet connection.

The bank server receives the request and responds with the Sign-In web page. Header information contained in the web page includes the Bank Global Unique Identifier (BGUID), the Transaction ID (TID), and the token TAG as recognized by the software interface. The software interface parses the header information and acknowledges the inclusion of the token TAG. The software interface parses out the header fields of the response and requests that the authentication server validates the BGUID as a trusted source. The request passes the BGUID, the TID and the IP of the bank server. This is performed via secure channels.

The authentication server validates the BGUID and IP against a known list of bank servers. The BGUID is trusted for the bank server IP and the authentication server generates an Authentication Code (AUTHCODE) which is stored against the BGUID, TID and IP. The AUTHCODE is returned in a formatted response to the software interface. This is performed via secure channels.

The software interface validates the response from the authentication server. The software interface generates a new request to the bank server to store the AUTHCODE against the Machine Global Unique Identifier (MGUID), TID and Finger Print Identifier (FPID). The request passes the AUTHCODE, MGUID, TID and FPID. The bank server stores the AUTHCODE against the MGUID, TID and the FPID. The bank server returns the Sign-In web page with the AUTHCODE embedded in the page.

The software interface passes this response directly through to the internet browser as no token TAG is included in the header information. The customer enters the Sign-In credentials, User ID (UID) and password (PWD), and submits the information to the bank server. The request passes the UID, PWD and the AUTHCODE.

The software interface passes the Sign-In request through to bank server. The bank server validates the UID and PWD as submitted by the customer. The customer credentials are then validated against the MGUID. The MGUID has been successfully activated by the customer previously and thus the UID and MGUID are deemed trusted sources.

The bank server allows access to retrieve the customer account details and returns information encrypted. The software interface passes this response directly through to the internet browser as no token TAG is included in the header information.

### 4. Example Scenario: Customer Submits Sign-In Credentials to a Phishing Site

A bank customer has registered and activated the software for internet banking services. At some time, post registration and activation, the customer receives a spam email fraudulently asking them to browse to a site posing as the authenticate bank site and enter their Sign-In credentials. The customer follows the instructions on their computer and unwittingly submits their Sign-In credentials to the Phishing web site. The Sign-In credentials are electronically posted to the perpetrators of the Phishing scam. The perpetrators use a different computer to the customer's computer and browse to the authenticate bank Sign-In web page and enter the customer's credentials. The authentication process rejects the perpetrator's attempt to access the customer's account details as the MGUID does not match that of the registered computer. The bank server responds with a message that the computer must be registered and to seek assistance by ringing a customer support number.

The perpetrators having gained the Sign-In credentials of the customer have no access rights to the account details as the attempted Sign-In is from a computer the authentication process deems to be not trusted.

The resultant no access rights also applies to legitimate bank customer attempting to Sign-In from a computer that they have not registered for the internet banking services.

In this case, the customer is a legitimate internet service customer with the bank, can not access account details from an unregistered computer. In effect the authentication process fails to establish a trust relationship between the customer and the computer, and hence treats this access as a potential unauthorized attempt.

To access the account details, the customer is required to register and activate each computer they wish to use, and would follow the procedures described above.

Advantages

The advantages of the preferred embodiment of the present invention include minimizing the threat of capital loss for individuals who disclose their security identity information to a phishing web site by introducing another layer of authentication, increasing security of internet access to the bank or financial institution through a three-way authentication between the bank or financial institution, a user and the user's computer; and increasing security of the banking process through the logging and recognition of known secure traffic between banks and users through the implementation of unique bank identifiers and communication protocols. Furthermore the cost of the implementation of the method to banks and the user is minimal requiring new software but no additional hardware or change of hardware.

Variations

It will of course be realised that while the foregoing has been given by way of illustrative example of this invention, all such and other modifications and variations thereto as would be apparent to persons skilled in the art are deemed to fall within the broad scope and ambit of this invention as is herein set forth.

Throughout the description and claims this specification the word “comprise” and variations of that word such as “comprises” and “comprising”, are not intended to exclude other additives, components, integers or steps.

We claim:

1. An authentication method for securely disclosing confidential information over the internet, comprising:
opening a secure site sign-in URL using a customer's computer which has been registered and activated for use by a customer with a secure site;
receiving secure site identification tags in a sign-in web page on the customer's computer from a secure site server;
sending the secure site identification tags from the customer's computer to an authentication server for validation as a trusted source;
validating the secure site identification tags by the authentication server and generating an authentication code;
sending to and validating the authentication code on the customer's computer and generating a request, comprising the authentication code, to the secure site;
returning the sign-in web page from the secure site with the authentication code embedded therein to the customer's computer;
entering sign-in information into the request and submitting the request to the secure site, said request comprising the authentication code;
validating the sign-in information against a unique identifier of the customer's computer recorded when registered and activated by the secure site;
wherein said verifying the sign-in information and the unique identifier confirms that the customer, customer's computer and the secure site are trusted sources.

2. An authentication method for securely disclosing confidential information over the internet, comprising:
opening a bank sign-in URL using a customer's computer which has been registered and activated for use by a customer for internet banking;
receiving bank identification tags in a sign-in web page on the customer's computer from a bank server;
sending the bank identification tags from the customer's computer to an authentication server for validation as a trusted source;
validating the bank identification tags by the authentication server and generating an authentication code;
sending to and validating the authentication code on the customer's computer and generating a request, comprising the authentication code, to the bank;
returning the sign-in web page from the bank with the authentication code embedded therein to the customer's computer;
entering sign-in information into the request and submitting the request to the bank, the request comprising the authentication code;
validating the sign-in information against a unique identifier of the customer's computer recorded when registered and activated by the bank;
wherein said verifying the sign-in information and the unique identifier confirms that the customer, customer's computer and the bank are trusted sources.

3. An authentication method as claimed in claim 2, wherein communication occur via interface software that is compatible with protocols of the bank.

4. An authentication method as claimed in claim 2, wherein the bank identification tags include a Bank Global Unique Identifier, a Transaction ID and a token TAG that is recognizable by computer software.

5. An authentication method as claimed in claim 4, wherein said validating the bank identification tags by the authentication server occurs by checking the Bank Global Unique Identifier and an IP address against a known list of bank servers.

6. An authentication method as claimed in claim 2, wherein the sign-in information comprises user identification and a password.

7. An authentication method as claimed in claim 2, wherein the unique identifier includes a Machine Global Unique Identifier and a Finger Print Identifier.

8. An authentication method as claimed in claim 2, wherein the bank is an entity where confidential or sensitive information is transferred between the customer and the entity.
